(19) United States
(12) Patent Application Publication
(10) Pub. No.: US 2022/0306352 A1
(43) Pub. Date: Sep. 29, 2022

(54) LID FOR A CUP

(71) Applicant: SEDA INTERNATIONAL PACKAGING GROUP SPA, Arzano Napoli (IT)

(72) Inventor: Gianfranco D'Amato, Arzano Napoli (IT)

(21) Appl. No.: 17/639,019

(22) PCT Filed: Aug. 27, 2020
(86) PCT No.: PCT/EP2020/073974

§ 371 Date: Feb. 28, 2022

(30) Foreign Application Priority Data
Aug. 30, 2019 (DE) 20 2019 104 776.3

(51) Int. Cl. B65D 43/02

(52) U.S. Cl. CPC B65D 43/0212; B65D 2231/022; B65D 2543/00046; B65D 2543/00092; B65D 2543/00268; B65D 2543/00731

(57) ABSTRACT

A lid for a cup for beverages may include an annular lid bottom part, which can be placed on an upper cup edge, and a substantially circular lid disk. The lid bottom part and lid disk may be made of paper and may be connected in a liquid-tight manner along an edge groove pointing downwards in the direction of the cup and along an edge flange. The edge flange may point upwards in the opposite direction and may be inserted in the edge groove.

### CROSS-REFERENCE TO RELATED APPLICATIONS

This application is a National Stage Patent Application of International Patent Application No. PCT/EP2020/073974, filed Aug. 27, 2020, which claims the benefit of German Application Serial No. 20 2019 104 776.3, Aug. 30, 2019, the contents of each are incorporated by reference in their entireties.

### TECHNICAL FIELD

The invention refers to a lid for a cup for beverages. Such a cup is, for example, made of paper or cardboard and has a liquid-tight coating on the inside. Such cups are recyclable or compostable and therefore ecologically better than cups made of plastic material. Such a cup is used for the consumption of cold or hot drinks and is usually closed at its upper open end by a corresponding lid. This lid must meet certain requirements with regard to tightness and firm fit on an upper cup rim.

### BACKGROUND

A respective cup with lid is described in EP 1 975 085 or EP 1 787 916, for example. Lids for such cups are known from EP 1 968 861 or EP 3 068 706. Another lid is described in DE 20 2005 018 987.

However, while the cups are already made of paper or cardboard with the appropriate coating, plastic materials such as polystyrene have been used for the various lids to date. Although these are easy to manufacture and handle and meet the requirements for tightness and a firm fit on the container, they are ecologically more questionable than the cup in terms of the material used.

### SUMMARY

The object of the present application is to improve a lid for a cup for beverages in such a way that it is largely made of paper, has a simple structure and satisfies the relevant requirements for tightness and a firm fit on an upper end of the cup.

An embodiment of the invention is characterized in particular by the fact that the lid has a lower lid part which can be placed on an upper cup rim and a substantially circular lid disc, the lower lid part and lid disc being made of paper and being joined in a liquid-tight manner along a rim groove pointing downwards in the direction of the cup and a rim flange pointing upwards in substantially the opposite direction, which is inserted into the rim groove. The lid is thus essentially made up of two parts, the lower part of the lid and the lid disc, which are joined together in a liquid-tight manner. The same construction can be used for lids which are placed on cups of different diameters, whereby only the radius of the lower lid part and the lid disc is adapted to the corresponding diameter of an upper opening of the cup. The lower lid part and the lid disc are each made of paper, cardboard or other paper material. They are easy to assemble, so that a large number of lids can be produced and assembled mechanically from individual parts in a short time.

Depending on the embodiment, the rim groove is formed by an upper rim of the lower lid part and the rim flange by a lid disc rim folded upwards or the rim groove is formed by a downwardly open rim ring of the lid disc and the rim flange by an upper end section of the lower lid part. In both cases, the rim flange is inserted into the rim groove and a liquid-tight connection is made. If the rim groove is formed by an upper rim of the lower lid part, this rim groove overlaps the corresponding rim of the lid disc and extends essentially to an upper side of the lower lid part. If liquid leaks onto the upper side of the lid, it may come into contact with the lower lid part and in particular with its rim groove. If the rim groove is formed by a rim ring of the lid disc which is open at the bottom, essentially the entire surface of the lid disc is bounded by this rim ring, so that liquid on the lid disc only comes into contact with material of the lid disc.

In the simplest case, the rim groove is essentially reverse U-shaped. The rim groove can have corresponding curves of a U-shape, but can also connect U-legs and U-web via edges.

To facilitate insertion of the rim flange into the rim groove, a depth of the rim groove may be substantially equal to a height or length of the rim flange. This allows easy insertion of the rim flange into the rim groove until a free end of the rim flange touches a bottom of the rim groove. In this context, bonding may be carried out not only along flat sides of the rim flange but also at its free end with a bottom of the rim groove.

In particular, the lower lid part ensures that the lid is placed securely on a cup. In order to adjust the lower lid part in this respect if necessary and to allow for different degrees of firmness of the lid on the cup, the lower lid part can be made of two, three or more layers of paper. These are connected to each other in a known manner and can be cut to form a blank for the lower lid part. It is also possible to produce the lower lid part from an elongated tube by cutting the tube in a slice-like manner. The lower lid part can then be deformed to ensure that it fits tightly on an upper rim of the cup. It is also conceivable that the paper layers are wound spirally.

It is usually sufficient for the lid disc to be formed from at least one layer of paper. The lid disc closes the lid at the top, but except for the connection with the lower lid part, it only serves to a small extent for the stability of the lid or to create a firm fit on the cup. However, it may be the lid disc that comes predominantly into contact with the liquid contained in the cup, so that it may be advantageous in this context if the lid disc has a liquid-tight plastic coating at least on its underside. Such a plastic coating can be a very thin layer of polyethylene, lacquer or the like, whereby biodegradable plastics can also be used, which can also be applied as an aqueous solution or as a layer on the underside of the lid, for example. If an aqueous solution is used, it may have a PET (polyethylene terephthalate) content. However, compared to a pure plastic coating, only a small percentage of this is contained in the aqueous solution. Furthermore, alternatively or additionally, a corresponding coating can be applied on an upper side of the lid disc or on an outer side of the lower lid part.

In order to create a liquid-tight connection between rim groove and rim flange in a simple manner, they can be bonded together. Such a bonding can be achieved by using an adhesive, for example. Bonding is also conceivable by means of the plastic coating on the underside or top side of the lid, which is melted a little during heat sealing, for example, and after re-curing creates the connection between the rim groove and rim flange in a liquid-tight manner. As already explained, the plastic coating can be biodegradable or at least separable from the lid. This also applies analogously to additionally used adhesives.

In particular, it can be considered advantageous if the lid is not only used to close the cup, but if it is also possible to remove the beverage without removing the lid from the cup. Several possibilities are conceivable for this. One example is the formation of a drinking straw insertion point in the lid disc, which can be opened in particular by inserting a drinking straw. The user will open the drinking straw insertion point by inserting the drinking straw and will push the drinking straw through the straw insertion point into the cup in order to be able to remove the beverage from the cup. Such a drinking straw insertion point can be formed essentially at any position in the lid disc, whereby an essentially central arrangement is also possible. In order to enable the drinking straw to be inserted without additional aids or to avoid a tip on the drinking straw for making an opening in the lid disc, the drinking straw insertion point may be formed by one or more cut lines at least partially penetrating the lid disc. Such cut lines may, for example, be arranged in an X-shape, so that the straw can be placed at the intersection of the legs of the X and then pressed through the lid disc at this point. It is also conceivable that such cut lines would completely penetrate the lid.

The lid disc is usually positioned at a distance from a liquid in the cup, so that even if the lid disc is penetrated by the cut lines, no leakage must occur. However, if the cut lines are only partially penetrating, the plastic coating, for example, is intact, so that the leakage of liquid can be safely avoided.

Instead of the X-shaped arrangement, other forms of cut lines are also conceivable.

In order to provide the user with further possibilities for removing the beverage, a drinking opening in the lid disc, which can be opened by the user, can be formed in addition or as an alternative to the drinking straw insertion point. Such a drinking opening can be used for direct consumption of the beverage from the cup, i.e. without using a drinking straw. Such a drinking opening is defined by a section of the lid disc, which is also formed, for example, by one or more cut lines at least partially penetrating the lid disc. In addition, a handle for pressing in or lifting off the corresponding lid disc section may be assigned to the drinking opening. Such a handle may, for example, be similar to a handle for aluminum beverage cans, although in this case the handle is made of paper. Furthermore, it is of course possible to use the handle not only to press the corresponding lid disc section essentially into the inside of the cup, but also to remove it at least partially or even completely from the lid.

In order to improve the tightness of the lid and at the same time to determine in a simple manner the appropriate position of the lid on the cup, it may also be advantageous if a supporting rim is formed at the lower end of the rim groove or rim flange of the lower part of the lid which is inclined substantially inwards. This supporting rim can rest on an upper free end of a rim of the cup, so that both the position of the lid can be determined thereby and a corresponding tightness can be improved by this contact between at least the lower lid part and the cup.

It has already been pointed out that several layers of paper can be used for at least the lower lid part. It may further be advantageous if the thickness of such paper layers is different. For example, in certain embodiments of the invention, the thickness of the lid disc can be 0.2-0.8 mm and of the lower lid part 0.6-1.2 mm.

However, these values are not fixed, as they may differ from the above values in terms of requirements for the lid or depending on the use for cold or hot drinks.

All in all, this results in a lid made of an ecologically harmless material that is easy to manufacture and handle, and at the same time meets all requirements with regard to tightness and firm fit on a cup. The lid sits firmly on the container, is liquid-tight and at the same time allows various ways of removing a beverage from the container.

It is also possible to remove the lid altogether and drink the beverage directly from the cup. The lid can also be used for different sizes of cups, whereby only the diameter of the lid disc and the lower lid part may be adjusted accordingly. The other features of the lid remain unchanged.

A plastic lid that can only be used once is replaced by the described lid with regard to all requirements.

In a further embodiment of the lid, it is conceivable that a further drinking opening is provided in addition or as an alternative to the drinking straw insertion point. This can be covered by a lid disc section closing the drinking opening in a substantially liquid-tight manner, this lid disc section being bounded by an at least partially circumferential tear line and an end fold line. The tear line may be formed by a corresponding perforation or by a cut line partially cut into the lid disc. Along the tear line, the lid disc section can be separated from the rest of the lid disc and folded around the end fold line. In this way, the drinking opening is opened.

In an embodiment, it is conceivable that the tear line has a front line section facing the rim groove and two side line sections running from this front line section in the direction of the fold line.

In this context, there is also the possibility that the front line section is convexly curved and the side line sections are essentially straight.

In order to limit a height of the lid disc section projecting above the lid disc in its open state when the lid disc section is opened and at the same time to have a reinforced handle when the lid disc section is torn open at least along the side line sections, the lid disc section may have a further, middle fold line extending for example between ends of the side line sections, which ends are connected to the front line section.

It is possible that this middle fold line runs essentially parallel to the end fold line. It is also conceivable, however, that instead of these two fold lines running in a straight line and their essentially parallel arrangement, an angle is provided between the directions of the fold lines or the fold lines are at least partially curved or wavy.

It is also possible for the middle fold line to be longer than the end fold line. A middle fold line of the same length or shorter than the end fold line is also conceivable.

The front line section and the middle fold line delimit a press-in section of the lid disc section. The middle fold line, the side line sections and the end fold line define a fold-up section of the lid disc section. The lid disc section is then usually opened in such a way that first the press-in section is pressed into the inside of the cup along the front line section to release it and swung downwards about the middle fold line, and then the fold-up section is raised by means of the pressed-in and inwardly folded-over press-in section, with a corresponding separation from the rest of the lid disc along the side line sections. Folding up the fold-up section is done via the end fold line. In the open position of the lid disc section, both the press-in section and the fold-up section are then located above the remaining lid disc, so that the drink-out site can be used easily. Thus, according to some embodiments of the invention, the lid disc section is folded twice around the middle fold line and the end fold line, and the lid disc section is separated along the side line sections and the front line section.

Furthermore, some embodiments of the invention refer to a lid disc section with the preceding features, see tear line, formed by the front line section and the two side line sections as well as end fold line, a convex front line section, straight side sections, a middle fold line as well as press-in section and fold-up section. Such a lid disc section may also be formed in other paper or cardboard lids which do not have the features of this application, for example, corresponding rim grooves, rim flanges or other features of the lid of this application.

Consequently, the lid disc section that closes the drinking opening is also disclosed.

### BRIEF DESCRIPTION OF THE DRAWINGS

In the following, advantageous embodiments of the lid are described in more detail using the Figures included in the drawings.

FIG. 1 shows a perspective top view of a cup with lid;

FIG. 2 shows a cut along a diameter of the lid as shown in FIG. 1 for a first embodiment;

FIG. 3 shows a cut analogous to FIG. 2 for a further embodiment, and

FIG. 4 shows a perspective top view of another embodiment of a lid according to the invention.

### DETAILED DESCRIPTION

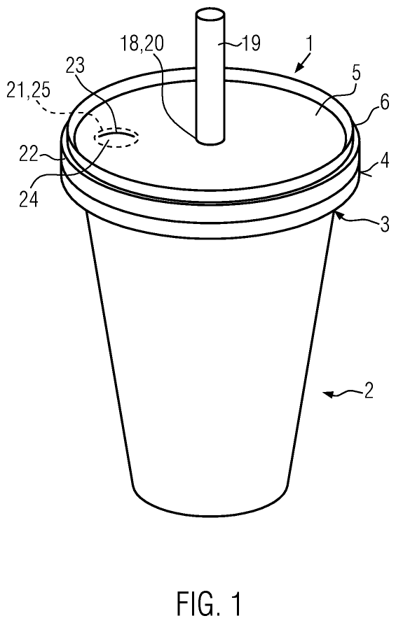

FIG. 1 shows a perspective view from an inclined position on top of a cup 2 with a lid 1. The cup 2 has an essentially truncated cone shape with an upper cup rim 3 on which the lid 1 is placed in an essentially liquid-tight manner. The lid 1 has a circular shape and comprises a lower lid part 4 and a lid disc 5. The lower lid part 4 is essentially annular and the lid disc 5 is essentially circular. Depending on the diameter of the cup 2 at its upper cup rim 3, the diameters of lid disc 5 and lid lower part 4 can be selected.

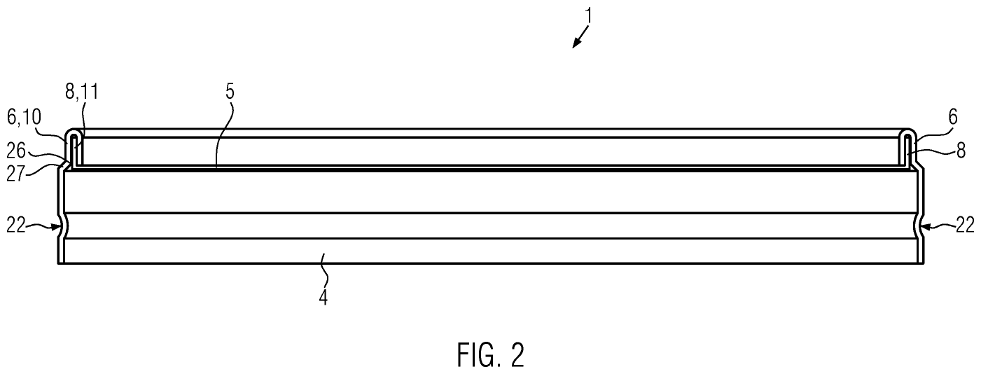

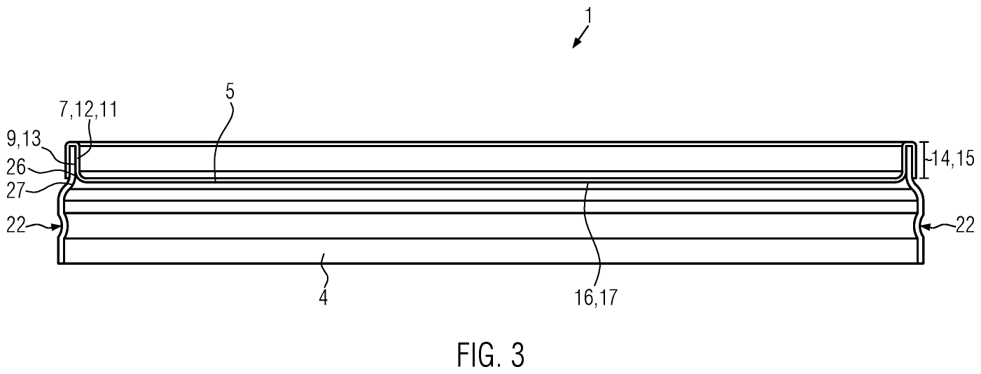

The lower lid part 4 has a structure in the height direction which, for example, has an inwardly projecting locking bead 22, see also FIGS. 2 and 3, which, for example when lid 1 is placed on cup 2, engages under a cup rim which is generally rolled over outwards.

The upper side of the lid disc 5 is essentially flat and, in the embodiment shown, has a drinking straw insertion point 18, which is formed by at least one cut line 20. A plurality of cut lines 20 are also conceivable, whereby these are arranged in an X-shape, for example, and a drinking straw 19 is placed with its lower end on a corresponding intersection of the cut lines 20 and then advanced through the lid disc 5 into the interior of the cup 2.

Furthermore, or as an alternative to the drinking straw insertion point 18, the lid disc 5 can have a drinking opening 21, which is designed, for example, as a lid disc section 24, which is bordered by a cut line 25. The shape of the lid disc section 24 can be circular or also formed in another way, for example drop-shaped in the direction of the rim groove 6. In order to press the lid disc section 24 into the inside of the cup or to lift it at least partially from the lid disc 5, a handle 23 can be arranged on the lid disc section 24.

It is also possible that the lid disc 5 has neither drinking straw insertion point 18 nor drinking opening 21, so that, for example, no drinking straw 19 or without additional aids can be used to pierce the lid disc.

In the embodiment of lid 1 according to FIG. 1, a rim groove 6 is formed by an upper rim 10, see also FIG. 2, of the lower lid part 4. The rim groove 6 has an essentially inverted U-shape and a rim flange 8 formed by the lid disc 5 is inserted into the rim groove 6. The rim flange 8 is formed by a lid disc rim 11 pointing upwards in FIG. 2. This is essentially completely inserted into the rim groove 6. Rim groove 6 and rim flange 8 or lid disc rim 11 are connected to each other in a liquid-tight manner.

At a lower end 26 of the rim groove 6, the lower lid part 4 has a supporting rim 27 which runs obliquely inwards. This is used, for example, for abutting from above and laterally against an upper cup rim 3, which is not shown in FIG. 2.

The lid disc rim 11 runs essentially perpendicular to the remaining lid disc 5, which extends between the circumferential rim groove 6 of the lower lid part 4.

A liquid-tight connection between the rim groove and rim flange can be achieved in all embodiments by means of an additional adhesive or by a plastic coating 17 applied to at least one underside of the lid disc 16 or upper side of the lid disc. In the latter case, the connection is made by heat sealing, for example.

It is also conceivable that the plastic coating 17 is not only applied to an underside 16 of the lid disc 5, but alternatively or additionally to its upper side and possibly to an outer side/inner side of the lower lid part.

In the embodiment shown in FIG. 3, the rim groove 7 is formed by a rim ring 12 at the lid disc rim 11. This also has an essentially inverted U-shape, into which a corresponding rim flange 9 of the lower lid part 4 is inserted from below, the rim flange 9 being formed by an upper end section 13 of the lower lid part 4. Also in the embodiment according to FIG. 3, a supporting rim 27 is formed substantially at the lower end 26 in this case of the rim flange 9 or the upper end section 13 of the lower lid part 4. Preferably a depth 14 of the rim groove 6, 7 corresponds to a height or length 15 of the corresponding rim flange 8, 9.

To simplify matters, FIGS. 2 and 3 do not show a drinking straw insertion point 18 or a drinking opening 21. A drinking straw insertion point 18 is usually not provided for hot beverages. Likewise, the drinking opening 21 can be a simple opening in the lid.

It should also be noted that the drinking opening 21, see FIG. 1, does not have to be at a distance from the corresponding rim groove 6, 7, but can also extend to and along the rim groove.

In both embodiments of FIGS. 2 and 3, the locking bead 22 is shown in each case, whereby there is an upper cup rim between this and the lower end 26 when lid 1 is placed on a cup 2. The locking bead 22 engages under the corresponding upper cup rim, which may be rolled over outwards.

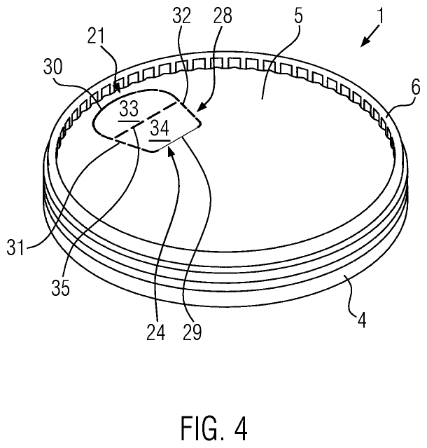

FIG. 4 shows a top view of another embodiment of a lid according to the invention. This has a lid disc section 24, which closes off a drinking opening 21 in the lid disc 5. The lid disc section has a press-in section 33 facing the rim groove 4 or 6 and an adjoining fold-up section 34. The press-in section 33 is bordered by a front line section 30 and a middle fold line 35. The front line section continues in two side line sections 31, 32, which end at an end fold line 29. The front line section and the side line section are tearable or can be pushed in and form a tear line 28 to separate the lid disc section from the remaining lid disc 5 along this line. The front line section 30 is essentially convexly curved and is assigned according to the rim grooves. The side line sections run in a substantially straight line, with the middle fold line running between their ends facing the front line section. In the embodiment shown, the middle fold line runs essentially parallel to the end fold line and is longer than it.

To open the lid disc section, the user presses the press-in section 33 with a finger so that it separates from the rest of the lid disc 5 along the front line section 30. If the press-in section is then pivoted towards the inside of the cup about the middle fold line, the lid disc section is further separated from the lid disc 5 along the side line sections 31, 32 and at the same time the fold-up section is folded upwards, together with the press-in section folded in relative to it, about the end fold line 29. In the open position of the lid disc section, it protrudes from the lid disc along the end fold line 29, the press-in section being at least partially pivoted in the

1. A lid for a cup for beverages, the lid comprising:
an annular lower lid part, which can be placed on an upper cup rim, and
a substantially circular lid disc,
wherein the lower lid part and the lid disc are made of paper and are connected in a liquid-tight manner along a rim groove pointing downwards in the direction of the cup and a rim flange pointing upwards in the opposite direction, said rim flange being inserted into the rim groove.

2. (canceled)

3. The lid according to claim 1, wherein the rim groove is formed by a downwardly open rim ring of the lid disc and the rim flange is formed by an upper end portion of the lower lid part.

4. (canceled)

5. (canceled)

6. The lid according to claim 1, wherein the lower lid part is formed by two, three or more layers of paper.

7. The lid according to claim 28, wherein the lid disc is formed of at least only one paper layer.

8. The lid according to claim 1, wherein the lid disc has a substantially liquid-tight coating on its lower side and/or upper side.

9. The lid according to claim 1, wherein the rim groove and rim flange are glued together.

10. (canceled)

11. The lid according to claim 1, wherein a drinking straw insertion point which can be opened in particular by inserting a drinking straw is formed in the lid disc.

12. (canceled)

13. The lid according to claim 11, wherein in addition to the drinking straw insertion point, a drinking opening, which can be opened by a user, is formed in the lid disc.

14. The lid according to claim 28, wherein the lower lid part has at least one inwardly projecting locking bead.

15. The lid according to claim 7, the drinking opening being formed by one or more cut line(s) at least partially passing through the lid disc.

16. (canceled)

17. The lid according to claim 28, wherein a substantially inwardly inclined supporting rim is formed substantially at the lower end of the rim groove or rim flange of the lower lid part.

18. The lid according to claim 6, wherein the thickness of the paper layers is different.

19. (canceled)

20. The lid according to claim 15, wherein a lid disc section closing the drinking opening is bounded by an at least partially circumferential tear line and an end fold line.

21. The lid according to claim 20, wherein the tear line comprises a front line section facing the rim groove and two side line sections extending from the front line section in the direction of the end fold line.

22. The lid according to claim 21, wherein the front line section is convexly curved and the two side line sections extend substantially straight.

23. The lid according to claim 22, the lid disc section having a further middle fold line extending substantially between ends of the side line sections, which ends are connected to the front line section.

24. The lid according to claim 23, with the middle fold line running substantially parallel to the end fold line.

25. (canceled)

26. The lid according to claim 24, wherein the front line section and the middle fold line define a press-in section of the lid disc section and the middle fold line, the side line sections and the end fold line define a fold-up section of the lid disc section.

27. A lid disc of a lid for closing a cup, the lid disc comprising:
a lid disc section that is configured to provide a drinking opening and is bounded by an at least partially circumferential tear line and an end fold line, the lid disc section including:
a press-in section; and
a fold-up section.

28. The lid according to claim 3, wherein the lower lid part is made from an elongated tube by cutting the tube in a slice-like manner.
